(19) United States
(12) Patent Application Publication
(10) Pub. No.: US 2004/0225435 A1
(43) Pub. Date: Nov. 11, 2004

(54) Traveling system for a driving vehicle

(75) Inventors: Satoshi Ogawa, Oyama-shi (JP); Kyoji Uranaka, Yokohama-shi (JP); Koichi Okamoto, Yokohama-shi (JP); Takao Nagai, Yokohama-shi (JP)

Correspondence Address: FRISHAUF, HOLTZ, GOODMAN & CHICK, PC, 767 THIRD AVENUE, 25TH FLOOR, NEW YORK, NY, 10017-2023, US

(73) Assignee: KOMATSU LTD., Tokyo (JP)

(21) Appl. No.: 10/805,664

(22) Filed: Mar. 18, 2004

(30) Foreign Application Priority Data
Mar. 19, 2003 (JP) 2003-075605

(51) Int. Cl. G06F 17/00

(52) U.S. Cl. 701/200; 701/1

(57) ABSTRACT

An assistance vehicle (A) is connected to a dump truck (D) on or at bases of ascending paths (T1, T2), and power is supplied as auxiliary power from the assistant vehicle A to a driving motor in the dump truck (D). Because of this feature, a driving unit of the dump truck (D) (a generator for supplying power to the driving motor in the dump truck (D) or a generating engine for driving the generator) is required only to have the performance sufficient for running on horizontal paths (H1 to H3), which enables size reduction of the driving unit and as a result cost reduction of the dump truck (D). Further the assistant vehicle (A) is connected to the dump truck (D) and moves together with the dump truck (D), so that a freedom degree of the dump truck (D) for a traveling path can substantially be improved.

### BACKGROUND OF THE INVENTION

1. Field of the Invention

The present invention relates to a traveling system for a driving vehicle.

2. Description of Related Art

A heavy-duty dump truck with the deadweight of, for instance, 100 tons has a driving engine or a driving motor as a driving unit. In the type of a dump truck having a driving engine, output from the driving engine is transmitted via a transmission to wheels. In the type of dump truck having a driving motor, a generator drives a generating engine, a driving motor is driven by the power generated by the generator, and the wheels are driven by output from the driving motor. The dump trucks as described above are used at many sites such as those for mining development, but the driving unit comprising a driving engine, an electric motor or the like is generally of heavy-duty, because the dump truck is required to travel, for instance, on an ascending path on a mine.

When a dump truck runs on a descending path or a horizontal path, the large output as that required when running on an ascending path is not required, so that the driving unit loaded on the dump truck is rather excessive. In other words, the driving unit is loaded to respond to the necessity of running up an ascending path without fail, which makes it rather difficult to reduce size of vehicles such as dump trucks. To solve the problem as described above, there has been a dump truck based on the trolley system (Refer to, for instance, Japanese Laid-Open Publication No. SHO 56-35604).

The technology described in this Patent Publication is applied to a dump truck having a driving motor, and in this system, an overhead wire facility is installed along an ascending path, and also a pantograph (a collector) is loaded on a dump truck, and electric power obtained by contacting this pantograph to this overhead wire is supplied to a driving motor. With this technology, when a large output such as that required when running on an ascending path is required, required electric power is supplied as auxiliary power from the outside to the driving motor, so that a generator loaded in the dump truck is required only to generate power required for running on an descending or horizontal path, and size reduction of a generator but also a vehicle itself is possible. Although not described in the Patent Publication, also the configuration is allowable in which, in addition to the driving engine, a driving motor is loaded in a dump truck running with the driving engine, and electric power is supplied as auxiliary power to this driving motor when the dump truck runs up an ascending path to assist the driving engine, and with this configuration, it is possible to reduce the size and cost of the driving engine or the like.

However, in the technology described in the Patent Publication, as an overhead wire facility provided on the ground is used as a facility for supplying electric power from the outside to a dump truck, there occurs the problem that the dump truck can travel on a path along which the overhead wire facility is installed and the travel area is extremely limited. In addition, the overhead wire facility is required to be installed each time the ascending path is extended, which disadvantageously necessitates large-scale countermeasures associating heavy workload and cost increase.

### SUMMARY OF THE INVENTION

A main object of the present invention is to provide a traveling system for a driving vehicle which can promote cost reduction for a driving vehicle and also can easily improve the freedom degree on a travel path without causing increase in workload and cost.

The traveling system for a driving vehicle according to the present invention comprises a driving vehicle capable of running with a driving unit, a driving motor loaded in the driving vehicle, and a power supply section capable of moving together with the driving vehicle and supplying a power to the driving motor, and is characterized in that this power supply section can easily be loaded on or off from the driving vehicle, and is loaded off from the driving vehicle when the driving vehicle runs in a low-duty mode and does not supply power for the driving motor, and also in that this power supply section is connected to the driving vehicle when the driving vehicle runs in a heavy-duty mode and supplies power to the driving motor.

The driving motor may constitute a portion of the driving unit, or may be provided not as a driving unit, but only to be used for traveling in the heavy-duty mode.

With the present invention, power is supplied to a driving motor for a driving vehicle from a power supply section according to the necessity, but the power supply section can freely be loaded on or off from a driving vehicle, and therefore, for instance, at a base of a slope, the power supply section may be connected to the driving vehicle to supply auxiliary power only during traveling on an ascending path, and the driving vehicle may be loaded off from the driving vehicle on a descending path or on a horizontal path for traveling by itself With the configuration, as power is supplied to the driving motor from the power supply section only during the heavy-duty traveling mode, so that the driving unit is required only to have the performance adapted to the low-duty traveling, and size reduction of the driving unit can be realized and also the cost reduction is possible. Further as the power supply section is loaded on a driving vehicle and moves together with the driving vehicle, so that a freedom degree of a traveling path for a driving vehicle can substantially be improved. In other words, response to change or extension of a traveling path can easily be performed by separating the power supply section at a prespecified place and setting it in the stand-by state or previously setting the power supply state in the stand-by mode at a prespecified place.

In the traveling system for a driving vehicle according to the present invention, the driving motor should preferably be capable of converting the kinetic energy of the driving vehicle to the electric energy, and further the power supply section should preferably have an accumulator for accumulating therein the regenerated electric energy.

Also in the conventional type of dump truck having the driving motor, the kinetic energy is converted to the electric energy with the driving motor as described above, and the electric energy is used for braking the vehicle. But in that case, the regenerated electric energy is further converted to heat by a resistor and is released to the atmospheric air, or is collected through an overhead wire in a case of a trolley dump truck. When an accumulator is provided in a driving vehicle itself, there is no way to prevent increase in size and weight of the driving vehicle because of the accumulator. Especially, in a case of a dump truck used on a long ascending path in a mine or the like, sometimes a high-capacity battery (accumulator) is required to be loaded on the driving vehicle, and for the reasons described above, reduction in size and weight of a driving vehicle has been difficult. In contrast, in the present invention, as the regenerated electric energy is accumulated in the accumulator of the power supply section, and therefore there is no possibility that the size of the driving vehicle increases. In addition, when regeneration of the electric energy is performed on a long descending path, by employing the configuration in which the descending path is divided to a plurality of zones and accumulation of the electric energy in the accumulator is performed by using a discrete power supply section in each zone, the discrete accumulator may be of low-capacity, which enables size reduction of the power supply section.

### BRIEF DESCRIPTION OF THE DRAWINGS

FIG. 1 is a simulated view showing the state in which a driving vehicle is running up on an ascending path by using a traveling system according to one embodiment of the present invention;

FIG. 2 is a simulated view showing the state in which a driving vehicle is running down on a descending path by using the traveling system according to the present invention;

FIG. 3 is a view showing the representative configuration of a driving vehicle used in the traveling system;

FIG. 4 is a simulated view showing configuration of a representative driving vehicle;

FIG. 5 is a simulated view showing other configuration of the representative driving vehicle;

FIG. 6 is a view showing the representative configuration of a power supply section used in the traveling system;

FIG. 7 is a simulated view showing configuration of a representative power supply section,

FIG. 9 is a simulated view showing another configuration of the representative power supply section;

FIG. 9 is a simulated view showing still another configuration of the representative power supply section;

FIG. 10 is a view showing a variant of the driving vehicle; and

FIG. 11 is a view showing a variant of the power supply section.

### DETAILED DESCRIPTION OF THE PREFERRED EMBODIMENT(S)

An embodiment of the present invention is described with reference to the related drawings.

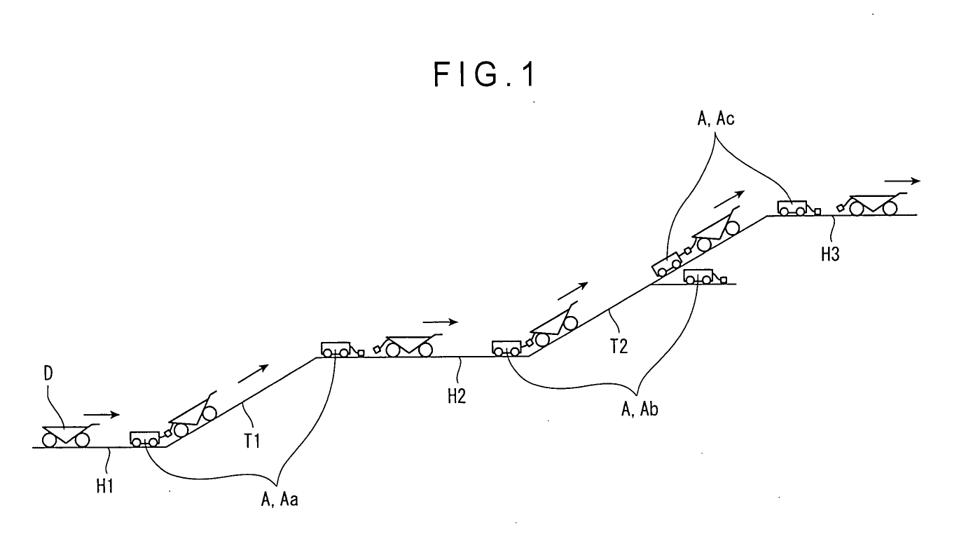

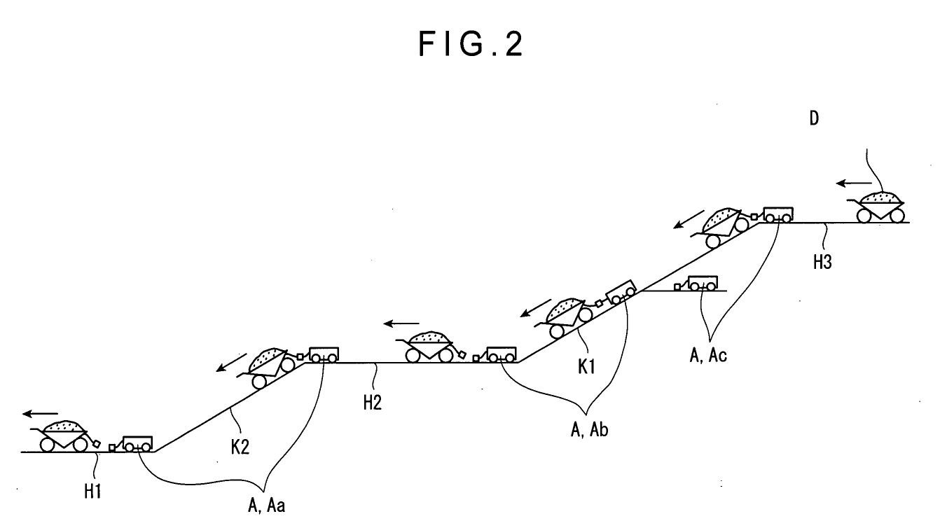

FIG. 1 is a simulated view showing the state in which a dump truck (driving vehicle) D is running up on an ascending path by using a traveling system according to the embodiment. FIG. 2 is a simulated view showing the state in which the dump truck D is running down on a descending path by using the traveling system. In this embodiment, a body of the dump truck D on the ascending path shown in FIG. 1 is empty, while the body of the dump truck D shown in FIG. 2 is filled with cargo, but the present invention is not limited to this configuration, and the present invention can respond to a case contrary to that described above.

Outline of the traveling system is as described below.

Namely, in the high-duty traveling mode in which a load to the driving unit is high like in a case in which the dump truck D is running on an ascending path, an assistant vehicle (power supply section) A is connected to the dump truck D to assist the driving power thereof, and in the low-duty traveling mode in which a load to the driving unit is low like in a case where the dump truck D is running on a horizontal path, the assistant vehicle A is separated from the dump truck D, and the dump truck D runs with a driving unit loaded on itself When running down on a descending path, conversion of the kinetic energy to the electric energy is performed in the dump truck D, and the regenerated electric energy (sometimes called as power) is accumulated in the assistant vehicle A.

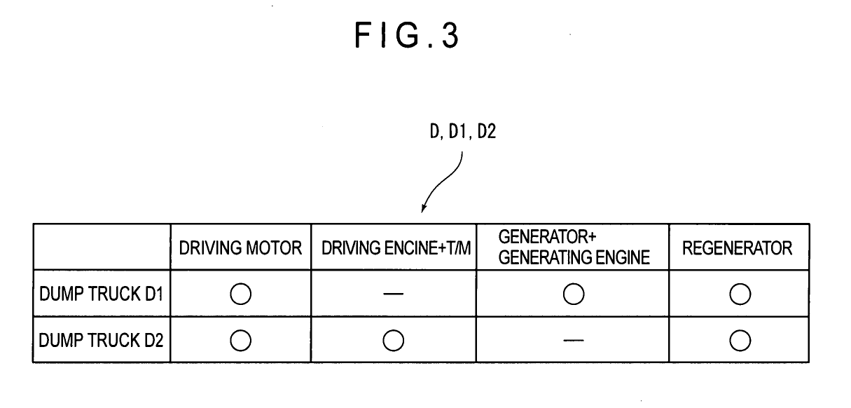

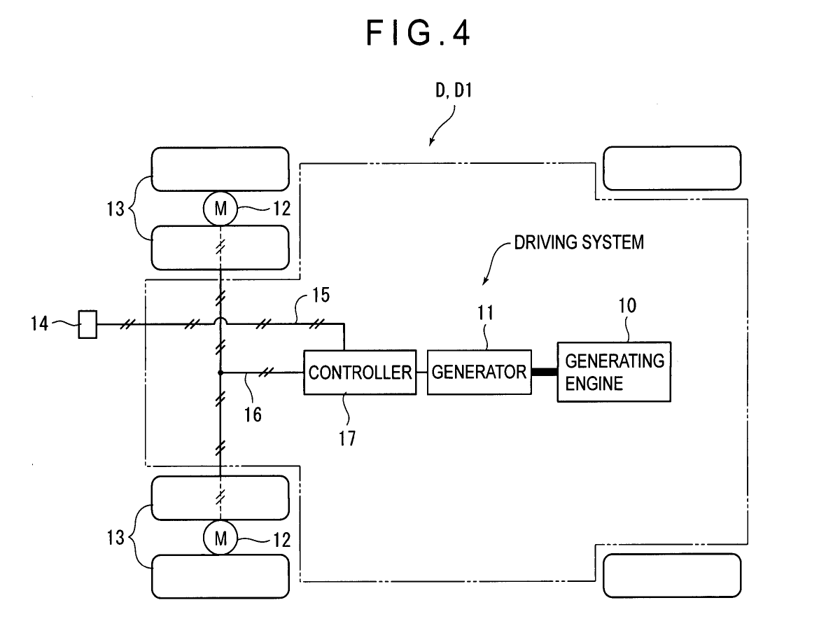

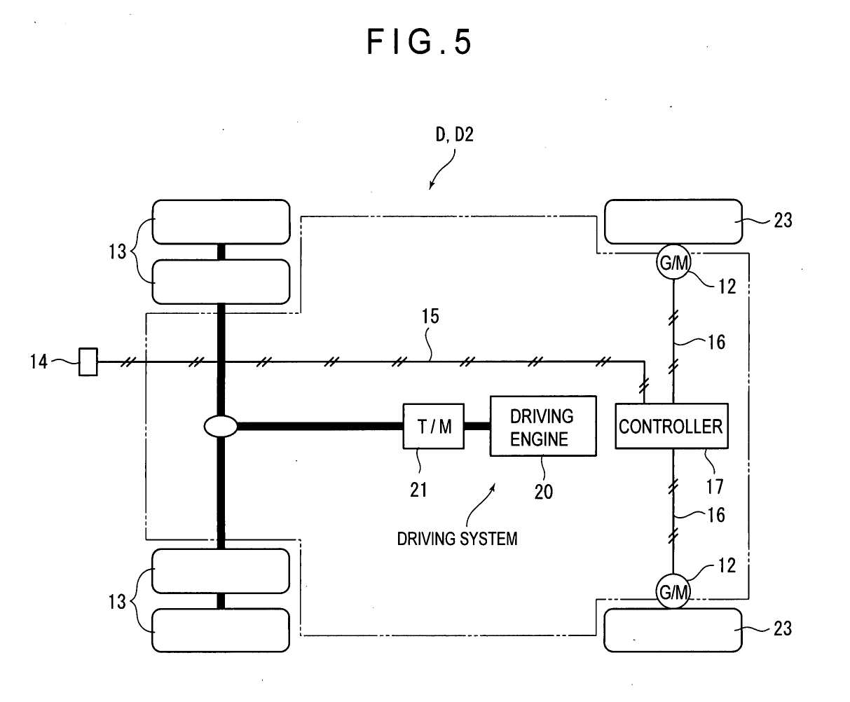

Various types of configuration are conceivable for the dump truck D used in the traveling system as described above, and as the representative examples thereof, dump trucks D1, D2 are shown in FIG. 3, and the simulated views are shown in FIG. 4 and FIG. 5.

The dump truck D1 shown in FIG. 3 and FIG. 4 has a driving unit comprising a generating engine 10 such as a diesel engine, a generator 11 driven by the generating engine 10, and a driving motor 12 driven by the power generated by the generator 11, and the rear wheels 13 are driven by the driving motor 12. In this step, the driving motor 12 also functions as a generator when used as a dynamic braking device. Namely, the driving motor 12 is capable of converting the kinetic energy of the dump truck D to the electric energy, and also functions as a regenerator as shown in FIG. 3.

Further provided in the dump truck D1 is a connector section 14 which can electrically and mechanically be loaded on or off from the assistant vehicle A (FIG. 1) in the state where the connector section projects toward the rear side in the traveling direction.

The connector section 14 is used for the driving vehicle to receive power from the assistant vehicle A as auxiliary power, and a power line 15 from the connector section 14 is connected to a controller 17 provided in the downstream side from the generator 11.

This controller 17 is provided on a power line 16 for supplying power from the generator 11 to the driving motor 12, and provides controls for receiving power from the assistant vehicle A, when the assistant vehicle A is connected to the connector section 14, and supplying the power, in addition to the power from the generator 11, to the driving motor 12.

Further the controller 17 fetches the power generated by the driving motor 12 (indicating the regenerated electric energy) through the power line 16 when the driving motor 12 functions as a generator, and returns the power via the power line 15 and the connector section 14 to the assistant vehicle A.

On the other hand, the dump truck D2 shown in FIG. 3 and FIG. 5 comprises a driving unit for driving rear wheels 13 comprising a driving engine 20 such as a diesel and a transmission 21 (shown as T/M in FIG. 5) linked thereto, and also has, in addition to the driving unit, the driving motor 12, connector section 14, and controller 17 like those in the dump truck D1. It is to be noted that, in FIG. 5, the same reference numerals are assigned to portions having the same functions as those in the dump truck D1.

It is to be noted that the driving motor 12 in the dump truck D2 is provided to drive the front wheels 23 and is used only in the heavy-duty traveling mode. Namely, when the assistant vehicle A is connected to the dump truck D2 in the heavy-duty traveling mode, the controller 17 fetches power from the assistant vehicle A and supplies the power to the driving motor 12 to drive the front wheels 23. With this operation, the driving motor 12 assists the driving engine 20, which makes it possible for the dump truck D to run in the heavy-duty traveling mode without raising load to the driving engine 20. It is needless to say that the controller 12 also provides controls for returning the electric energy generated by the driving motor 12 to the assistant vehicle A, as described above.

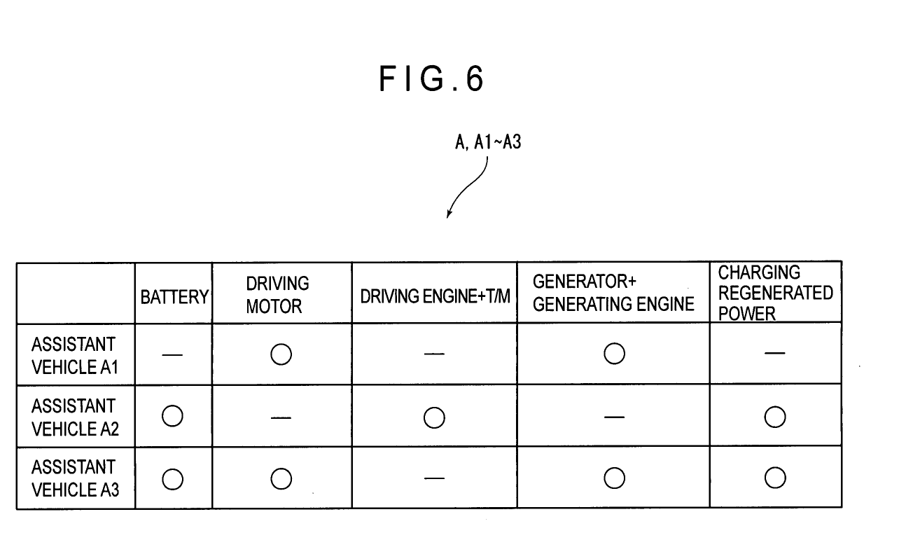

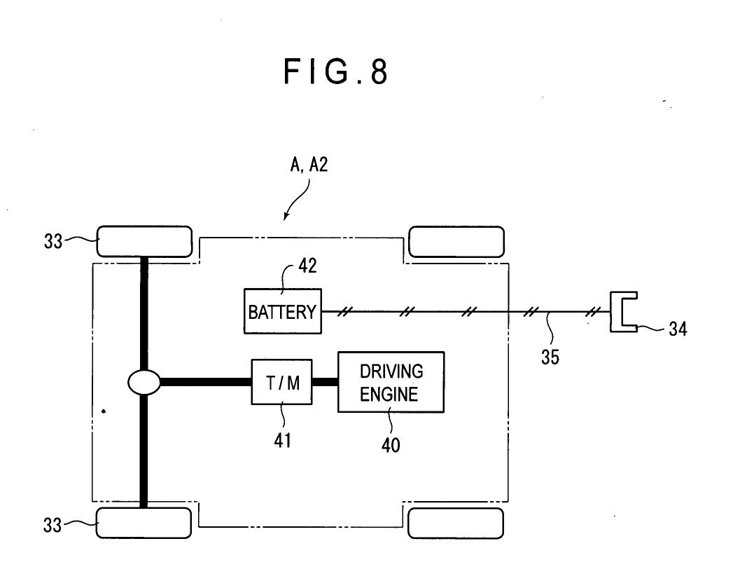

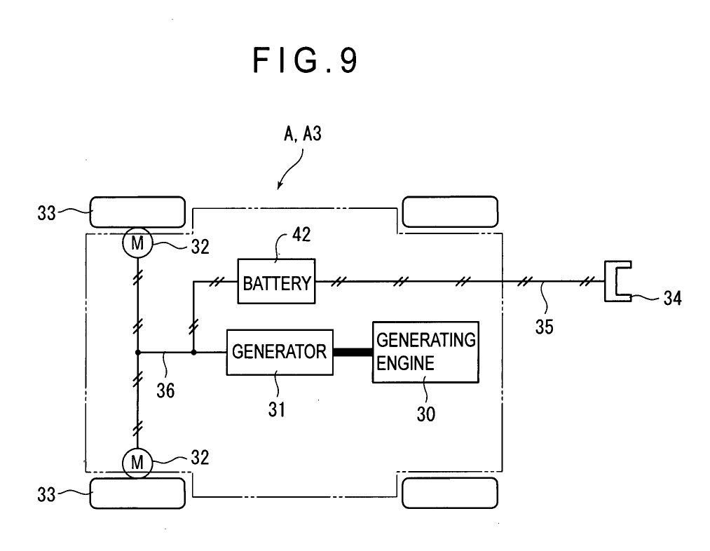

FIG. 6 to FIG. 9 show the assistant vehicles A1 to A3 each having the representative configuration of the assistant vehicle A used in the traveling system. It is to be noted that, in FIG. 8 and FIG. 9 showing the assistant vehicles A2 and A3 respectively, the same reference numerals are assigned to the parts and components having the same parts and functions as those of the assistant vehicle A1.

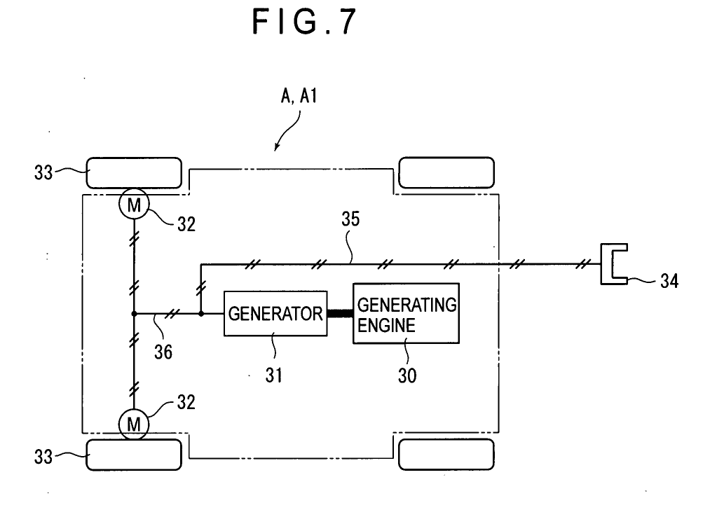

The assistant vehicle A1 shown in FIG. 6 and FIG. 7 has an generating engine 30 such as a diesel engine, a generator 31 driven by the engine 30 above, and a driving motor 32 driven by the power generated by the generator 31, and can travel by itself by driving rear wheels 33 with the driving motor 32 (shown as M in FIG. 7). However, this driving motor 32 is not used as a dynamic braking device in this embodiment, and the regeneration from the kinetic energy to the electric energy is not performed therein.

In the assistant vehicle A1, a connector section 35 connected to the connector section 34 of the dump truck D (shown in FIG. 4, FIG. 5) in the state where the former can electrically and mechanically be loaded to and off from the latter is provided in the state where it extends toward forward in the moving direction. Further a power line 35 to the connector section 34 branches from a power line 36 from the generator 31 to the driving motor 32.

With the configuration as described above, a portion of the power generated by the generator 31 is supplied via the power line 35 and the connector section 34 to the dump trucks D1 and D2.

The assistant vehicle A2 shown in FIG. 6 and FIG. 8 comprises a driving engine 40 such as a diesel engine and a transmission 41 linked thereto, and can travel by itself by driving the rear wheels 33.

Provided in the assistant vehicle A2 is a battery (accumulator) 42 rechargeable at a dedicated power station on the ground or the like, and power is supplied from this battery 42 to the dump truck D. This battery 42 has also the function to accumulate the electric energy fed back from the dump truck D where regeneration is performed in the driving motor 12 in the dump truck D.

The assistant vehicle A3 shown in FIG. 6 and FIG. 7 has the configuration in which the battery 42 is loaded on the power line 35 for the assistant vehicle A1 shown in FIG. 7, and a portion of the power generated by the generator 31 is once stored in this battery 42. With this configuration, the regenerated electric energy can be stored in the assistant vehicle A3, although it is impossible in the assistant vehicle A1 in the dump truck D.

Although not shown in the figure, the configuration is allowable in which the controller is provided in any of the assistant vehicles A1 to A3 according to the necessity for providing controls for a supply rate of power or storage of the regenerated electric energy.

An example of administration of the traveling system according to the present invention is described below with reference to FIG. 1 and FIG. 2.

At first, in FIG. 1, when the dump truck D is running on a first horizontal path H1 at a base of a mine, as the duty is low, the dump truck runs with its own driving unit. For instance, in the dump truck D1, the driving motor 12 is driven by the power from the generator 11 driven by the generating engine 10, and the dump truck D1 runs based on this driving power. The dump truck D2 runs depending on the power generated by the driving engine 20.

When the dump truck D reaches a start port for a first ascending path T1, the connector section 34 of the assistant vehicle Aa is connected to the connector section 14 of the dump truck D, and the dump truck D starts ascending the first ascending path T1 together with the assistant vehicle Aa. The dump truck D runs up on this first ascending path T1 in the high-duty traveling mode, and in a case where, for instance, the assistant vehicle A1 follows the dump truck D as the assistant vehicle Aa, a portion of the power supplied from the generator 31 driven by the generating engine 30 is consumed for traveling of the assistant vehicle A1 itself, but the remaining portion is supplied to the driving motor 12 in the dump truck D, so that output from the driving motor 12 increases to assist traveling of the dump truck D. When the assistant vehicle A2 follows the dump truck D, the assistant vehicle A2 runs with the power generated by the driving engine 40 for traveling, and also the electric power from the battery 42 loaded thereon as a single body is supplied to the driving motor 12 in the dump truck D to assist its traveling. When the assistant vehicle A3 follows, power is supplied from the battery 42 with the power generated by the generator 31 accumulated therein.

When the dump truck D has finished running up on the first ascending path T1 and runs on a second horizontal path H2, the traveling mode is shifted to the low-duty traveling mode, so that the assistant vehicle Aa having following the dump truck D is separated and is left there in the stand-by state. Then the dump truck D again runs on the second horizontal path H2 with its own driving unit up to a start port of a second ascending path T2.

To run up on the second ascending path T2, another assistant vehicle Ab having been set in the stand-by state is connected to the dump truck D, and the dump truck D starts traveling in the heavy-duty mode followed by the assistant vehicle Ab.

When the second ascending path T2 is long and there are the possibilities of; for instance, shortage of fuel for the generating engine 30 in the assistant vehicle A1 or A3, or shutoff of the battery 42 in the assistant vehicle A2 with the power supply from the assistant vehicle Ab to the dump truck D stopped on the second ascending path T2, still another assistant vehicle Ac is prepared on the second ascending path T2, and the assistant vehicle Ab is exchanged with the assistant vehicle Ac, so that the dump truck D can run up to a top of the second ascending path T2.

Further, when the dump truck finishes running up to the top of the second ascending path T2, the assistant vehicle Ac is separated and set in the stand-by state there, and the dump truck D starts running with its own driving unit on a third horizontal path H3.

On the other hand, when the dump truck D with cargo loaded thereon runs down to a base of a descending path, at first the assistant vehicle Ac having been separated therefrom is connected to the dump truck D having returned thereof running with its own driving unit on the third horizontal path H3, and the dump truck D descends the first descending path K1 (which is the same as the third ascending path T2) followed by this assistance vehicle Ac.

In this step, as the driving motor 12 in the dump truck D is used as a dynamic braking device, the kinetic energy of the descending dump truck D, more specifically power generated by rotation of the rear wheels 13 or the front wheels 23 are converted to the electric energy by the driving motor 12 which functions as a generator. Because of this feature, when the assistant vehicle A2 or A3 with the battery 42 loaded thereon is used as the assistant vehicle Ac, the electric energy returned from the dump truck D is accumulated in the battery 42.

When the dump truck D has run down to a certain point of the first descending path K1, the electric energy equal to the potential energy lost because the dump truck D and the assistant vehicle Ac run down on the first descending path K1 is returned to the assistant vehicle Ac. (Actually, power smaller than the consumed power is returned because of the conversion efficiency or the energy loss during transmission through the power line).

Then, at a point on the first descending path K1, the assistant vehicle Ac is exchanged with the assistant vehicle Ab, and the dump truck further descends. The energy conversion and accumulation in the battery are performed likely to those in the case of the assistant vehicle Ac.

When the dump truck D has run down to the base of the first descending path K1, the assistant vehicle Ab is separated, and the dump truck D runs on the second horizontal path H2 with its own driving unit for the second descending path K2 (which is the same as the first ascending path T1). At a start point of the second descending path K2, the assistant vehicle Ab having been separated when ascending is connected thereto, and the dump truck D descends as far as the first horizontal path H1. Further on the first horizontal path H1, the assistant vehicle Aa is separated, and the dump truck D returns with its own driving unit.

With the embodiment as described above, there are provided the effects as described below.

(1) Namely, the assistant vehicles Aa, Ab, and Ac are connected to the dump truck D used in this traveling system at bases of or on the ascending paths T1, T2 on which the dump truck D is required to run in the heavy-duty traveling mode, and power is supplied as auxiliary power from the assistant vehicles Aa, Ab, Ac to the driving motor 12, and therefore large power is outputted in response to the need of traveling in the heavy-duty mode, so that the driving unit is required only to have the performance satisfying the needs during traveling in the low-duty mode on the first to third horizontal paths H1 to H3 Accordingly, the generating engine 10 and the generator 11 constituting the driving unit of the dump truck D and the driving engine 20 and the transmission 21 in the dump truck D2 can be size-reduced, and also the cost and the like of the dump trucks D1, D2 as a whole can be reduced. Further weight of the dump truck D can be reduced because of the size reduction of the driving unit, so that improvement in the fuel cost and increase in the load capacity can be realized.

(2) Further the assistant vehicle A is connected to the dump truck D and moves together with the dump truck D, so that a freedom degree of the dump truck D on a traveling path can substantially be improved. Namely by making the assistant vehicle Ac wait in the stand-by state at a point on the ascending path T2, the dump truck D can run up even on a long ascending path T2 easily without fail. In addition, even when the ascending path is changed, by separating the assistant vehicle A at a top of the ascending path and set the assistant vehicle A in the stand-by state, the assistant vehicle A can be connected to the dump truck D again, and thus flexible response to change of a traveling path is possible without providing an overhead wire facility like that used in the conventional technology.

(3) In the dump truck D, the electric energy obtained by conversion from the kinetic energy is not accumulated therein but is returned to the assistant vehicle A and is accumulated in the battery 42, and therefore there is not the possibility that the size and weight of the dump truck D increase due to the battery 42, and the fuel cost or the like can be reduced without fail.

(4) In addition, when conversion from the kinetic energy to the electric energy is carried out on the long descending path K1, the first descending path K1 is divided to a plurality of zones (two zones in this embodiment), and the recovered electric energy can be accumulated in discrete batteries 42 of the assistant vehicles Ab, Ac in the zones respectively, and therefore a capacity of each battery 42 may be small, which enables size reduction of the assistant vehicles Ab, Ac.

The present invention is not limited to the embodiment described above, and includes other embodiments enabling achievement of the object of the present invention, and also the modifications and changes as described below are included within the scope of the present invention.

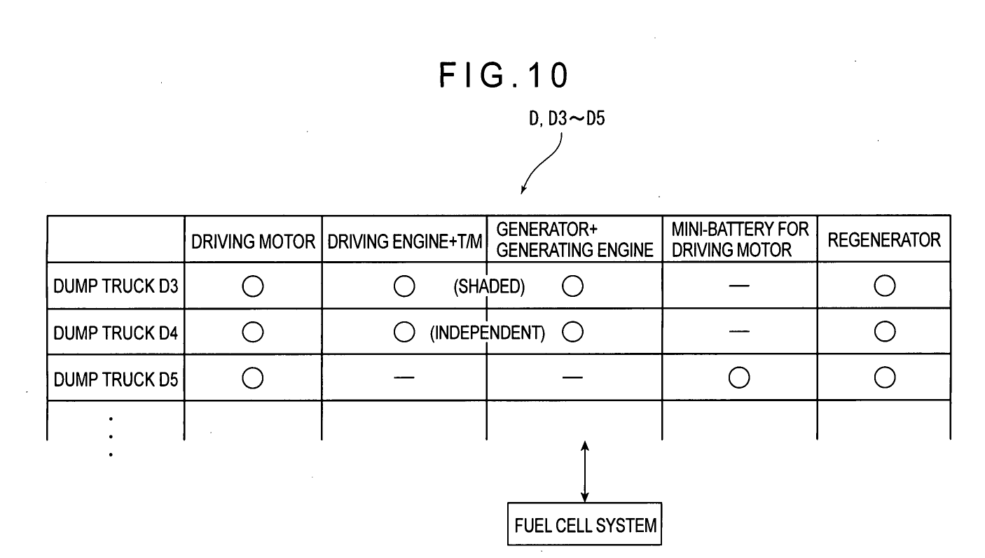

For instance, the dump truck D is not limited to the dump trucks D1, D2 described above, and the dump trucks D3. D4, D5 . . . as shown in FIG. 10 may be used as the dump truck D.

The dump trucks D3, D4 each comprise a driving unit comprising the driving motor 12, the generator 11 for supplying power thereto, and the generating engine 10 driving the generator 11 like those shown in FIG. 3 and FIG. 4, and further comprises a driving unit comprising the driving engine 20 and the transmission 21 also like those shown in FIG. 3 and FIG. 4, and different types of driving unit are used together in each of the dump trucks D3, D4. In the dump truck D3, the generating engine 10 driving the generator 11 is the same as the driving engine 20, while the generating engine 10 and the driving engine 20 are provided discretely.

The dump truck D5 is the so-called electric vehicle in which only a compact size battery for driving the driving motor 12 is loaded thereon.

In the dump trucks D1, D3, and D4 described above, a functional section comprising the generating engine 10 and the generator 11 may be replaced with a fuel cell system.

The vehicle capable of traveling by itself and used in the present invention is not limited to the dump truck D, and any type of vehicle having the driving motor 12 may be used in the present invention.

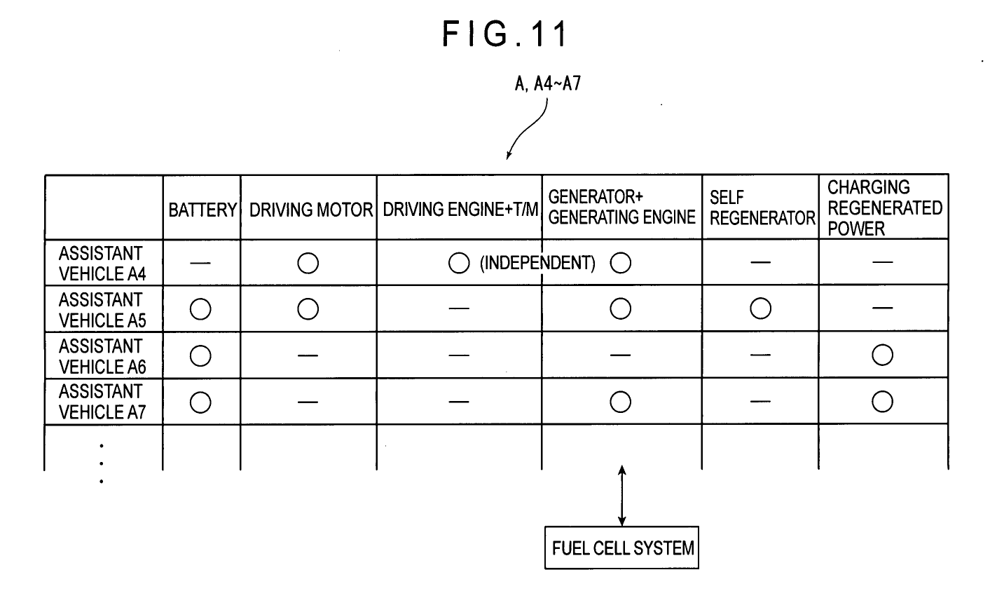

The assistant vehicle A is not limited to the assistant vehicles A1 to A3 described in the embodiment above, and any of the assistant vehicles A4, A5, A6, A7, . . . shown in FIG. 11 may be used for the same purpose.

The assistant vehicle A4 has, in addition to the driving unit comprising the electric motor 32, the generator 31 for supplying power to the electric motor 32 as well as to the dump truck D, and the generating engine 30 driving this generator 31 like those in FIG. 7 to FIG. 9, a driving unit comprising the driving engine 40 and the transmission unit 41 also like those shown in FIG. 7 to FIG. 9, and one of the different type driving unit is used for driving the rear wheels, and the other one is used for driving the front wheels. With the configuration as described above, the battery 42 is not provided, so that the energy recovered from the dump truck D can not be accumulated therein In the assistant vehicle A4, the generating engine 30 and the driving engine 40 are provided discretely, but one engine may be used for the two functions.

Further, the assistant vehicle A4 may have the configuration in which the electric vehicle 32 is omitted therefrom and the generator 31 is used only for supplying power to the dump truck D.

The assistant vehicle A5 is characterized in that it comprises a self recovery section. Namely, the driving motor 32 used in this configuration is used as a dynamic braking device and functions also as a generator, and when the dump truck D runs down on a descending path, a portion of the braking force applied to the dump truck D is borne by the assistant vehicle A5, and the electric energy is recovered by the driving motor 32. It is needless to say that a self recovery section is provided also in the assistant vehicle A4 described above.

The assistant vehicle A6 is a tracked vehicle having only the battery 42, and is tracked in the normal operating mode by driving force from the dump truck D. Power supply to the battery 42 is performed from a power supply station or the like on the ground.

The assistant vehicle A7 supplies power for the battery 42 incorporated therein from the generator 31 driven by the generating engine 30.

Also in the assistant vehicles A1, A3 to A5, A7 described above, the functional section comprising the generating engine 30 and the generator 31 may be replaced with a fuel cell system.

The power supply section according to the present invention is not limited to a traveling or tracked vehicle, and may be a unit type of power supply device which can freely be loaded on or off from a main body of a traveling vehicle, and if the unit is attached to a traveling in the heavy-duty traveling mode, or is removed from the main body in the low-duty traveling mode, the unit is the power supply section as defined in the present invention.

Further the best configuration and method for carrying out the present invention were disclosed above, but the present invention is not limited to the configurations and methods described above. Namely, although the present invention was illustrated and described with reference to the specific embodiments, but various modifications to the embodiments described above in terms of form, quantity, and other details can easily be made by those skilled in the art without departing from the technological idea, objects, and scope of the present invention.

Therefore, the configuration described above is only an illustrative one provided so that the present invention will be understood more, and does not limit the present invention in any sense, and therefore descriptions without using a portion or all of limitations on forms and component names are also within the scope of the present invention.

What is claimed is:

1. A traveling system for a driving vehicle comprising a driving vehicle capable of driving with its driving unit, a driving motor incorporated in the driving vehicle, and a power supply section capable of moving together with said driving vehicle and supplying power to the motor, wherein said power supply section can freely be loaded on or off from said driving vehicle and is disconnected from said driving vehicle in a low-duty traveling mode and power is not supplied to said driving motor, and the power supply section is connected to said driving vehicle in a heavy-duty traveling mode to supply power to said driving motor.

2. The traveling system for a driving vehicle according to claim 1,
wherein the kinetic energy of said driving vehicle is converted to the electric energy, and
wherein said power supply section has an accumulator for accumulating therein the regenerated electric energy.

3. The traveling system for a driving vehicle according to claim 1, wherein said driving motor is partially shared by said driving unit.

4. The traveling system for a driving vehicle according to claim 3, wherein said driving vehicle has a driving unit comprising a generating engine, a generator driven by the generating engine, and a driving motor driven by the power generated by the generator.

5. The traveling system for a driving motor according to claim 1, wherein said driving motor is provided independently from said driving unit and especially for running in the heavy-duty traveling mode.

6. The traveling system for a driving vehicle according to claim 5, wherein said driving vehicle comprises a driving unit comprising a driving engine and a transmission connected thereto, and further has a driving motor provided independently from the driving unit.

7. The traveling system for a driving vehicle according to claim 1, wherein said power supply section is configured as a power supply vehicle linked to said driving vehicle, connector sections mutually connectable to each other are provided in the power supply vehicle and said driving vehicle.

8. The traveling system for a driving vehicle according to claim 7, wherein said power supply vehicle can drive by itself.

9. The traveling system for a driving vehicle according to claim 8, wherein said power supply vehicle comprises a generating engine, a generator driven by the driving engine, and a driving motor driven by the power generated by the generator.

10. The traveling system for a driving vehicle according to claim 8, wherein said power supply vehicle comprises a driving engine and a transmission connected thereto, and also has an accumulator capable of accumulating therein and supplying power supplied from outside to said driving vehicle.

11. The traveling system for a driving vehicle according to claim 8, wherein said power supply vehicle comprises a generating engine, a generator driven by the generating engine, and a driving motor driven by the power generated by the generator, and also has an accumulator capable of accumulating therein the power from the generating engine and/or the power supplied from the outside and supplying the accumulated power to said driving vehicle.
